(19) United States
(12) Patent Application Publication
(10) Pub. No.: US 2013/0078551 A1
(43) Pub. Date: Mar. 28, 2013

(54) METHOD FOR MANUFACTURING UNIT CELLS OF SOLID OXIDE FUEL CELL

(71) Applicants: Ho Sung Kim, Suwon-si (KR); Young Mi Kim, Jeongeup-si (KR); Ju Hee Kang, Gwangju (KR); Duck Rye Chang, Gwangju (KR); Jong Ho Lee, Gwangju (KR); Chang Seog Kang, Gwangju (KR); Chaehwan Jeong, Gwangju (KR); Jae Hyuk Jang, Suwon-si (KR)

(72) Inventors: Ho Sung Kim, Suwon-si (KR); Young Mi Kim, Jeongeup-si (KR); Ju Hee Kang, Gwangju (KR); Duck Rye Chang, Gwangju (KR); Jong Ho Lee, Gwangju (KR); Chang Seog Kang, Gwangju (KR); Chaehwan Jeong, Gwangju (KR); Jae Hyuk Jang, Suwon-si (KR)

(73) Assignee: KOREA INSTITUTE OF INDUSTRIAL TECHNOLOGY, Cheonan-si, Chungcheongnam-do (KR)

(21) Appl. No.: 13/702,653

(22) PCT Filed: Jun. 24, 2011
(86) PCT No.: PCT/KR2011/004632

§ 371 Date: Dec. 7, 2012

(30) Foreign Application Priority Data
Jun. 25, 2010 (KR) 1020100060657
Jun. 24, 2011 (KR) PCT/KR2011/004632

(51) Int. Cl. H01M 8/00

(52) U.S. Cl. CPC H01M 8/00
USPC 429/535

(57) ABSTRACT

A manufacturing method for a solid oxide fuel cell (SOFC) unit cell is disclosed. The manufacturing method may include manufacturing an Ni—CeScSZ anode layer; manufacturing a CeScSZ electrolyte layer; manufacturing a gadolinia-doped ceria (GDC) buffer layer; and manufacturing a lanthanum strontium cobalt ferrite (LSCF) cathode layer. Accordingly, an ohmic resistance of electrolyte and a polarization resistance may be reduced and high output may be obtained even at a middle low temperature.

### TECHNICAL FIELD

The present invention relates to a manufacturing method for a solid oxide fuel cell (SOFC) unit cell, and more particularly, to a manufacturing method for a high output SOFC unit cell employing a high density thin film gadolinia-doped ceria (GDC) buffer layer.

### BACKGROUND ART

A fuel cell enables generation of a direct current (DC) by directly converting chemical energy of fuel into electrical energy.

That is, the fuel cell refers to an energy conversion device to generate DC electricity by causing an electrochemical reaction between an oxidizer such as oxygen and a gas fuel such as hydrogen using an oxide electrolyte. The fuel cell is different from other conventional cells in that electricity is continuously generated by supply of fuel and air from the outside.

The fuel cell includes a molten carbonate fuel cell (MCFC) operating at a high temperature, a solid oxide fuel cell (SOFC), a proton exchange membrane fuel cell (PEMFC), a direct methanol fuel cell (DMFC), and the like.

Here, the SOFC is in the form of a multilayered stack of unit cells, which include an anode, an electrolyte, and a cathode.

The SOFC may generate electricity and water through an electrochemical reaction at a high temperature of about 1000° C. by an oxidation reaction of fuel such as hydrogen and a reduction reaction of oxygen, that is, the air. Accordingly, the SOFC shows a highest power generation efficiency among the fuel cells and is easily capable of cogeneration using hot flue gas.

Generally, yttria-stabilized zirconia (8YSZ) is used as the electrolyte in the SOFC. Cermet (NiO/8YSZ) in which nickel oxide (NiO) and the 8YSZ are mixed is used as the anode. In addition, mixture of an LSM-based material, for example La0.8Sr0.2MnO3, and YSZ powder is generally used as the cathode.

However, due to durability and cost matters of the SOFC caused by the high temperature operation, early commercialization of the SOFC is being delayed. To overcome such limits, researches are in progress to reduce the operation temperature from the high temperature of about 900° C. to about 1000° C. to a middle low temperature of about 600° C. to about 800° C.

However, when the operation temperature is relatively lowered, an ohmic resistance of the electrolyte and a polarization resistance of electrodes may be increased, thereby reducing the output of the fuel cell.

Therefore, to prevent a voltage reduction caused by reducing the operation temperature, the electrolyte may be thinned into a thin film or an electrolyte material having high ion-conductivity may be used.

That is, researches are performed to achieve a high output unit cell by selecting an electrolyte having higher ion-conductivity than the YSZ, for example 1Ce10ScSZ electrolyte having high ion-conductivity, and selecting a proper anode reaction layer such as Ni—CeScSZ and a cathode material such as lanthanum strontium cobalt ferrite (LSCF).

### DISCLOSURE OF INVENTION

### Technical Goals

An aspect of the present invention provides a method of manufacturing a high density gadolinia-doped ceria (GDC) buffer layer to maximize characteristics of CeScSZ electrolyte having high ion conductivity.

Another aspect of the present invention provides a method of manufacturing a high density GDC buffer layer to minimize a reaction of CeScSZ electrolyte and a lanthanum strontium cobalt ferrite (LSCF) cathode caused by the GDC buffer layer.

### Technical Solutions

According to an aspect of the present invention, there is provided a manufacturing method of a solid oxide fuel cell (SOFC) unit cell including manufacturing a Ni—CeScSZ anode layer, manufacturing a CeScSZ electrolyte layer deposited on the anode active layer, manufacturing a gadolinia-doped ceria (GDC) buffer layer deposited on the electrolyte layer, and manufacturing a lanthanum strontium cobalt ferrite (LSCF) cathode layer deposited on the GDC buffer layer.

### Effects

According to the present invention, an ohmic resistance and a polarization resistance of an electrolyte may be reduced.

In addition, an abnormal reaction occurring between CeScSZ electrolyte and a lanthanum strontium cobalt ferrite (LSCF) cathode may be efficiently controlled, thereby achieving a high output even at a middle low temperature.

In addition, since a number of manufacturing processes of a solid oxide fuel cell (SOFC) unit cell is reduced, manufacturing cost may be reduced.

### BRIEF DESCRIPTION OF DRAWINGS

FIG. 1 is a diagram illustrating a structure of a solid oxide fuel cell (SOFC) unit cell according to an embodiment of the present invention;

FIG. 2 is a flowchart illustrating a manufacturing process of the SOFC unit cell according to the embodiment of the present invention;

FIG. 3 is a scanning electron microscope (SEM) sectional view of the unit cell according to the embodiment of the present invention;

FIG. 4 is an enlarged view of a gadolinia-doped ceria (GDC) buffer layer shown in FIG. 3;

FIG. 5 is a graph illustrating current-voltage relations of the unit cell according the an embodiment of the present invention;

FIG. 6 is graph illustrating an impedance of the unit cell according to the embodiment of the present invention;

FIG. 7 is an SEM sectional view of an SOFC unit cell according to a comparison embodiment of the present invention;

FIG. 8 is an enlarged view of a GDC buffer layer shown in FIG. 7;

FIG. 9 is a graph illustrating current-voltage relations of the unit cell according to the comparison embodiment of the present invention;

FIG. 10 is a graph illustrating an impedance of the unit cell according to the comparison embodiment of the present invention;

FIG. 11 is an SEM sectional view of an SOFC unit cell according to another comparison embodiment of the present invention;

FIG. 12 is an enlarged view of a GDC electrolyte layer shown in FIG. 11;

FIG. 13 is a graph illustrating current-voltage relations of the unit cell according to another comparison embodiment of the present invention; and

FIG. 14 is a graph illustrating an impedance of the unit cell according to another comparison embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. However, the aspect of the present invention is not limited to the embodiments and may be suggested in different manners by addition, alteration, and deletion of components of the embodiments, which still belongs to the aspect of the present invention.

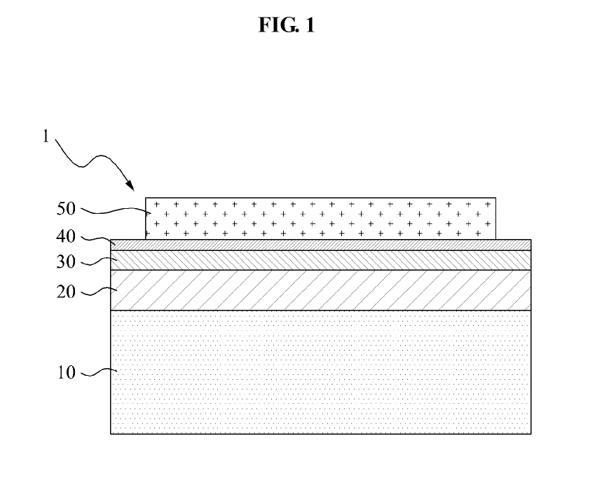

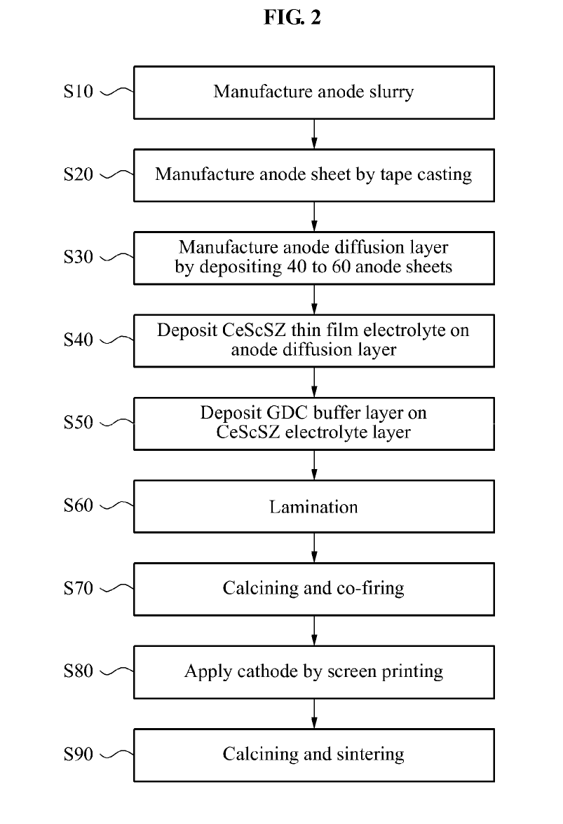

FIG. 1 is a diagram illustrating a structure of a solid oxide fuel cell (SOFC) unit cell 1 according to an embodiment of the present invention. FIG. 2 is a flowchart illustrating a manufacturing process of the SOFC unit cell 1 according to the embodiment of the present invention.

Referring to FIGS. 1 to 4, the SOFC unit cell 1 may include an anode diffusion layer 10, an anode active layer 20, an electrolyte layer 30, a gadolinia-doped ceria (GDC) buffer layer 40, and a cathode layer 50.

Cermet (NiO/8YSZ) in which nickel oxide (NiO) and the yttria-stabilized zirconia (8YSZ) are mixed may be used as the anode diffusion layer 10. The anode diffusion layer 10 may be manufactured by tape casting. According to the tape casting, ultra fine ceramics powder is mixed with an aqueous or non-aqueous solvent, a binder, a plasticizer, a dispersing agent, an antifoaming agent, a surfactant, and the like at a proper mixing ratio, thereby producing ceramics slurry. Next, the ceramics slurry is shaped as desired into a predetermined thickness on a moving carrier film. The anode diffusion layer 10 may be formed into the thickness of about 0.1 mm to about 1.5 mm.

The anode active layer 20 may include Ni—CeScSZ, for example NiO/1Ce10ScSZ, proper for a high ion-conductive CeScSZ electrolyte. The anode active layer 20 may be manufactured by tape casting. The anode active layer 20 may be deposited on the anode diffusion layer 10. For example, the anode active layer 20 may be formed into a thickness of about 5 μm to about 50 μm.

The anode diffusion layer 10 and the anode active layer 20 may be referred to as an anode layer.

The electrolyte layer 30 may include a CeScSZ electrolyte, for example 1Ce10ScSZ, having high ion conductivity. The electrolyte layer 30 may be manufactured by tape casting. The electrolyte layer 30 may be deposited on the anode active layer 20. For example, the thin-film electrolyte electrolyte 20 may be formed into a thickness of about 2 μm to about 20 μm.

Thus, an anode-supported electrolyte assembly may be constructed as the anode active layer 20 and the electrolyte layer 30 are deposited on the anode diffusion layer 10.

The GDC buffer layer 40 may include gadolinium doped ceria (GDC), for example, 10Gd90Ce. The GDC buffer layer 40 may be manufactured into a high density thin film by tape casting to minimize reactivity of the high ion-conductive CeScSZ and high conductive lanthanum strontium cobalt ferrite (LSCF). The GDC buffer layer 40 may be manufactured by co-firing on the anode-supported electrolyte layer.

The GDC buffer layer 40 may be formed as a high density thin film to minimize reactivity and electrochemical polarization resistance. The GDC buffer layer 40 may easily contact the electrolyte layer 30 and the cathode layer 50. Additionally, the GDC buffer layer 40 may be manufactured by co-firing with the anode diffusion layer 10, the anode active layer 20, and the electrolyte layer 30.

The cathode layer 50 may include LSCF including La₁₋ₓSrₓCo_{y}Fe_{1-y} and GDC. The cathode layer 50 may be applied onto the GDC buffer layer 40 by screen printing. For example, the cathode layer 50 applied on the GDC buffer layer 40 may be in a thickness of about 20 μm to about 50 μm.

Hereinafter, the manufacturing process of the unit cell 1 will be described in detail.

First, to form the slurry (ink) of the anode diffusion layer 10, ratio of NiO and 1CeScSZ is maintained at 60:40 and additives such as a finishing agent, a binder, a dispersing agent, and the like are applied in operation S10.

An anode sheet of about 40 μm thickness is manufactured by tape casting of the slurry in operation S20. About 40 to 60 anode sheets are deposited, thereby forming an anode diffusion layer 10 of about 1.0 mm to about 1.5 mm thickness in operation S30.

Next, the anode active layer 20 may be manufactured into a film of about 20 μm thickness by tape casting. For example, the anode active layer 20 may include a single sheet of film of about 20 μm thickness.

Next, the electrolyte layer 30 is deposited on the anode active layer 20 in operation S40. The electrolyte layer 30 may be manufactured into a thickness of about 10 μm by tape casting using CeScSZ powder having a surface area of about 20 to 40 m²/g. For example, the electrolyte layer 30 may include a single sheet of film of about 20 μm thickness manufactured by tape casting.

The GDC buffer layer 40 may be deposited on the electrolyte layer 30 in operation S50.

In detail, the GDC buffer layer 40 may be adapted to prevent reduction in performance of the unit cell 1 caused by a reaction of CeScSZ and LSCF. To manufacture the GDC buffer layer 40, slurry is produced by maintaining ratio of GDC powder, for example 10Gd90Ce, with respect to additives such as a binder, a dispersing agent, a solvent, and the like to about 40:60.

The slurry is manufactured into a thin film of about 3 μm to about 5 μm thickness by tape casting and the thin film is deposited on the electrolyte layer 30.

The GDC buffer layer 40 may be deposited on the CeScSZ electrolyte layer 30. Simultaneously, lamination may be performed by a force of about 400 kgf/cm² at about 70° C. for about 20 minutes, in operation S60.

In addition, calcining and co-firing are performed with respect to an assembly of the anode-supported electrolyte and the GDC buffer layer 40 in operation S70.

In details, a temperature of the anode-supported electrolyte may be increased up to about 1000° C. to remove the solvent and the binder of the slurry and to remove finishing agent carbon. The anode-supported electrolyte may be maintained for about 3 hours and then maintained at a normal temperature. At a temperature lower than about 1000° C., although flexure of the anode-supported electrolyte may not occur but anode-supported electrolyte may be not sintered and therefore easily broken. At a temperature higher than about 1000° C., flexure of the anode-supported electrolyte may be serious. Therefore, calcining of the anode-supported electrolyte may be performed at about 1000° C.

As aforementioned, the assembly of the anode-supported electrolyte and the GDC buffer layer 40 manufactured by tape casting and co-firing may be pressurized by a force of about 38 g/cm² and co-fired at about 1300° C. to about 1500° C.

Next, the cathode layer 50 maintaining the ratio of about 60:40 of LSCF and GDC may be applied to a thickness of about 30 μm to about 60 μm by screen printing, in operation S80.

In addition, calcining and sintering may be performed at about 1100° C., thereby completing manufacturing of the unit cell 1 in operation S90.

The SOFC unit cell 1 manufactured according to the present embodiment may efficiently control abnormal reactions occurring between the CeScSZ electrolyte and the

LSCF cathode. Accordingly, a high output may be obtained even at a middle low temperature. In detail, since about 0.1 S/cm of the CeScSZ electrolyte may be obtained at about 800° C., high ion conductivity may be achieved even in a thick film of about 10 μm to about 20 μm. Furthermore, the high output may be achieved by efficiently controlling reactivity with the LSCF cathode having high electrochemical activity and and conductivity.

In addition, since the anode, the electrolyte layer, and the buffer layer are collectively manufactured by tape casting and co-firing of the assembly, the unit cell may be produced at a relatively low cost. That is, since the anode, the thin film electrolyte, and the GDC buffer layer are simultaneously manufactured by tape casting, four or five processes for manufacturing the unit cell 1 may be reduced to two processes. Thus, the manufacturing cost may be reduced.

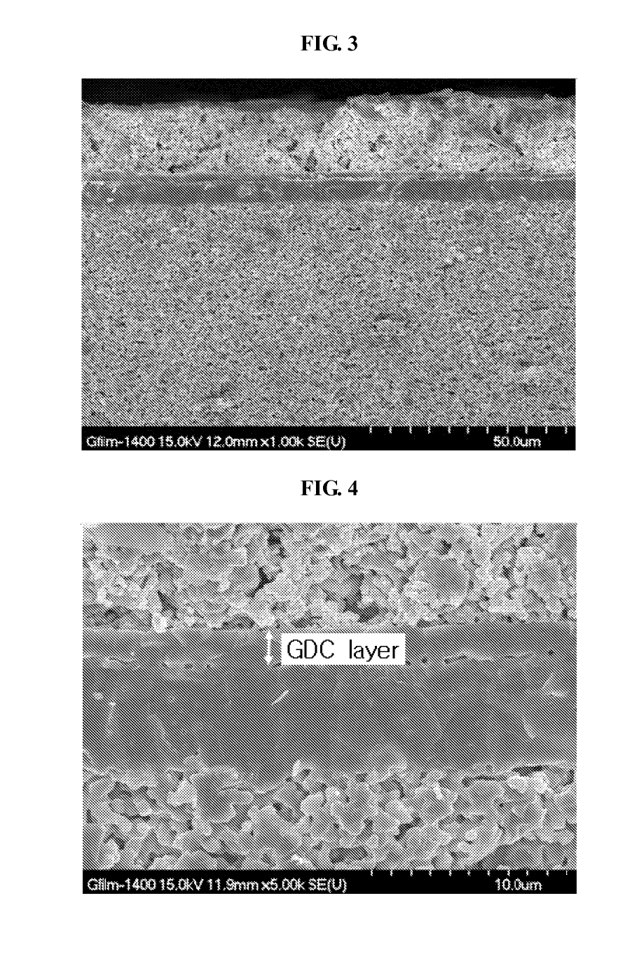

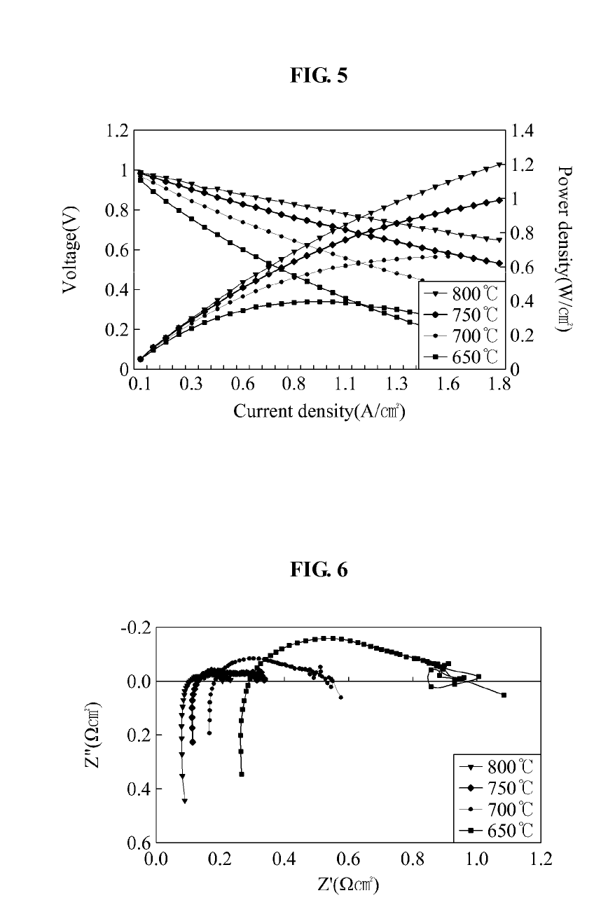

FIG. 3 is a scanning electron microscope (SEM) sectional view of the unit cell 1 according to the embodiment of the present invention. FIG. 4 is an enlarged view of a GDC buffer layer shown in FIG. 3. FIG. 5 is a graph illustrating current-voltage relations of the unit cell 1 according to the embodiment of the present invention. FIG. 6 is graph illustrating an impedance of the unit cell 1 according to the embodiment of the present invention.

Referring to FIGS. 3 and 4, in the unit cell 1 manufactured according to the foregoing process, the anode diffusion layer 10, the anode active layer 20, the electrolyte layer 30, and the GDC buffer layer 40 are co-fired through deposition. The cathode layer 50 is finally applied by coating. In addition, it may be understood that the GDC buffer layer 40 in the form of a thin film forms a uniform and minute structure with high density between the electrolyte layer 30 and the cathode layer 50.

The GDC buffer layer 40 may form a high density thin film of about 1 μm to about 2 μm. The CeScSZ electrolyte layer 30 may form a high density thin film of about 5 μm to about 7 μm.

With respect to the SOFC unit cell 1 manufactured by the foregoing process, hydrogen including about 3% of H₂O is flown at about 800° C. to the anode active layer 20 at a speed of about 200 ml/min. In addition, air is flown to the cathode layer 50 at a speed of about 300 ml/min. The graph of FIG. 5 shows a result of measuring a current-voltage (I-V) curve of an electrode manufactured using an electrical loader after reduction is performed for 2 hours.

With respect to the SOFC unit cell 1 manufactured by the foregoing process, hydrogen including about 3% of H₂O is flown at about 800° C. to the anode active layer 20 at a speed of about 200 ml/min. In addition, air is flown to the cathode layer 50 at a speed of about 300 ml/min. The graph of FIG. 6 shows a result of an impedance experiment (5 mV, 100 kHz-0.01 Hz) performed to measure an ohmic resistance of the electrolyte layer 30 and a polarization resistance of the electrode.

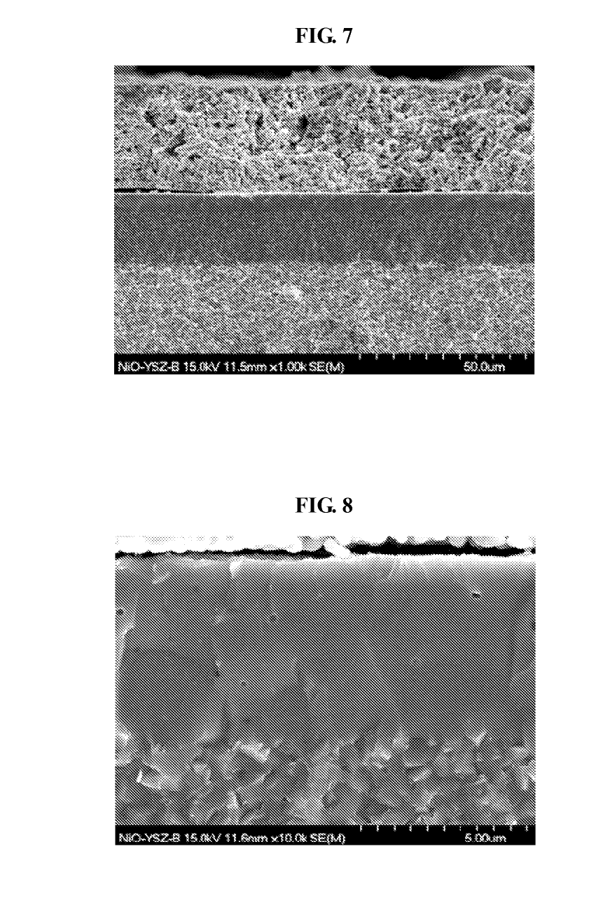

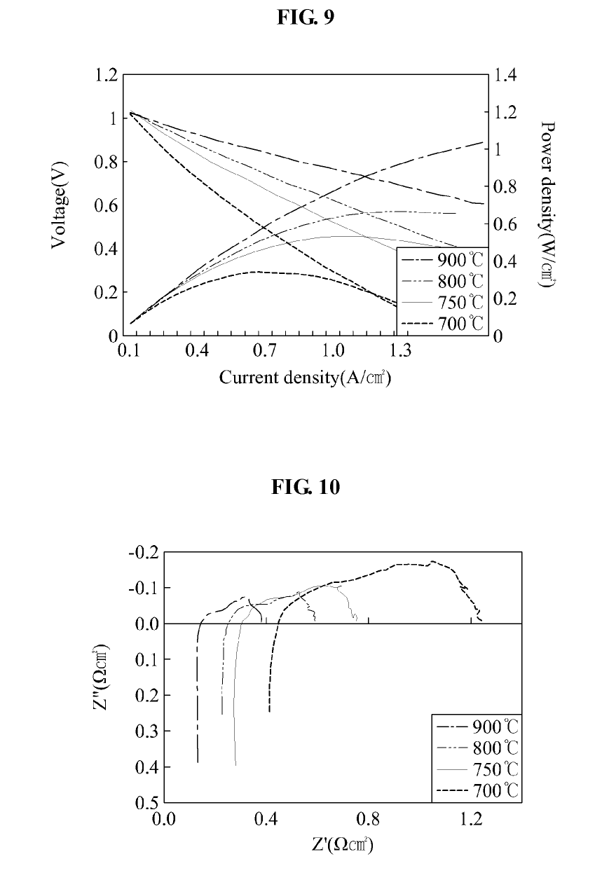

FIG. 7 is an SEM sectional view of an SOFC unit cell according to a comparison embodiment of the present invention. FIG. 8 is an enlarged view of a GDC buffer layer shown in FIG. 7. FIG. 9 is a graph illustrating current-voltage relations of the unit cell according to the comparison embodiment of the present invention. FIG. 10 is a graph illustrating an impedance of the unit cell according to the comparison embodiment of the present invention.

Referring to FIGS. 7 and 8, the comparison embodiment is different from the previous embodiment in that the GDC buffer layer and a cathode layer are manufactured by screen printing. The other features are the same as in the previous embodiment.

Also, referring to FIGS. 7 and 8, the GDC buffer layer manufactured by screen printing of the comparison embodiment is not sufficiently confirmed. In addition, bonding defect at an interface between the electrolyte layer and the cathode layer is confirmed.

With respect to the SOFC unit cell 1 manufactured according to the comparison embodiment, hydrogen including about 3% of H₂O is flown at about 800° C. to the anode active layer 20 at a speed of about 200 ml/min. In addition, air is flown to the cathode layer 50 at a speed of about 300 ml/min. The graphs of FIGS. 9 and 10 respectively shows a result of measuring an I-V curve of an electrode manufactured using an electrical loader after reduction is performed for 2 hours and a result of an impedance experiment (5 mV, 100 kHz-0.01 Hz) performed to measure an ohmic resistance of the electrolyte layer 30 and a polarization resistance of the electrode.

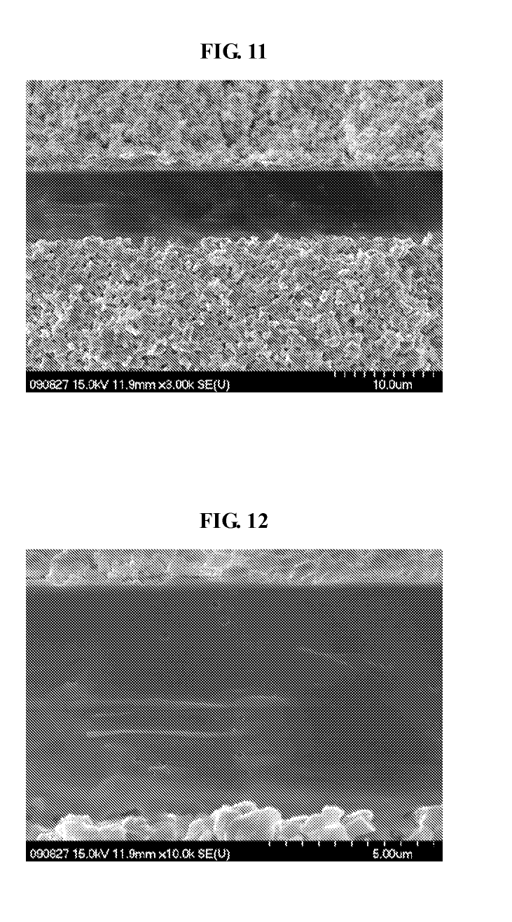

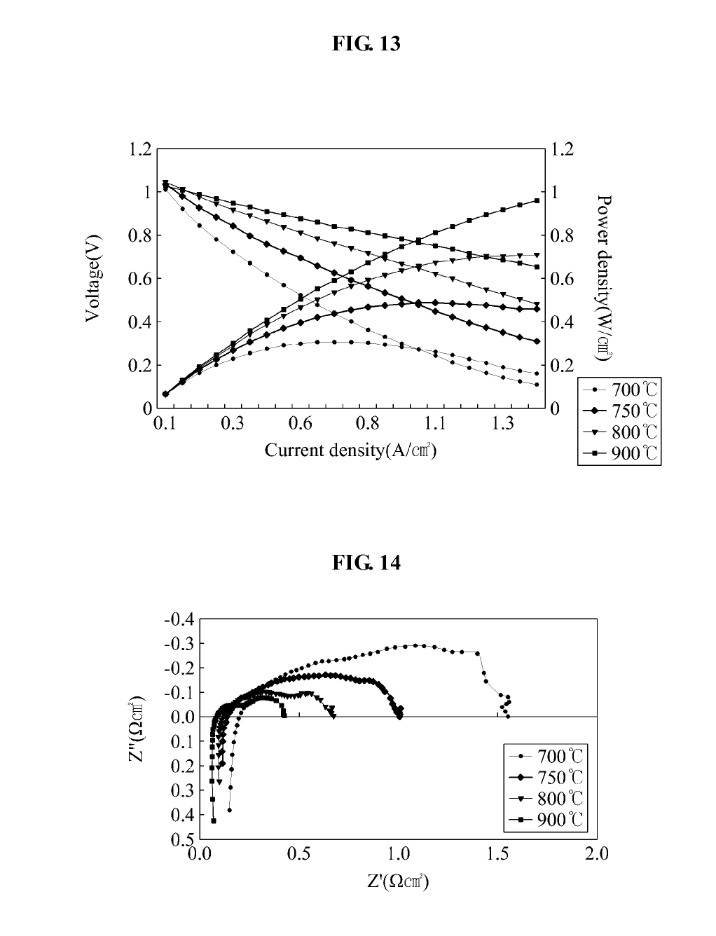

FIG. 11 is an SEM sectional view of an SOFC unit cell 1 according to another comparison embodiment of the present invention. FIG. 12 is an enlarged view of a GDC electrolyte layer shown in FIG. 11. FIG. 13 is a graph illustrating I-V relations of the unit cell 1 according to another comparison embodiment of the present invention. FIG. 14 is a graph illustrating an impedance of the unit cell according to another comparison embodiment of the present invention.

Referring to FIGS. 11 and 12 according to another embodiment, different from the previous embodiment, about 10 m²/g of YSZ powder is used instead of the CeScSZ electrolyte in an electrolyte layer, and LSM-YSZ is used instead of LSCF/GDC in a cathode layer. In addition, a GDC buffer layer is not used. The other features are the same as in the previous embodiment.

With respect to the SOFC unit cell 1 manufactured according to another comparison embodiment, hydrogen including about 3% of H₂O is flown at about 800° C. to the anode active layer 20 at a speed of about 200 ml/min. In addition, air is flown to the cathode layer 50 at a speed of about 300 ml/min. The graphs of FIGS. 13 and 14 respectively shows a result of measuring an I-V curve of an electrode manufactured using an electrical loader after reduction is performed for 2 hours and a result of an impedance experiment (5 mV, 100 kHz-0.01 Hz) performed to measure an ohmic resistance of the electrolyte layer 30 and a polarization resistance of the electrode.

The I-V curves are measured and the impedance experiments are performed with respect to the embodiment, the comparison embodiment, and another comparison embodiment to compare performances of the embodiment, the comparison embodiment, and another comparison embodiment. The results are summarized by Table 1.

TABLE 1

| | | | Polarization | |
|---|---|---|---|---|
| | Max output (W/cm²) | | resistance (mΩ/cm²) | |
| Items | 800° C. | 700° C. | 800° C. | 700° C. |
| Embodiment | 1.20 | 0.62 | 0.15 | 0.3 |
| Comparison embodiment | 0.65 | 0.30 | 0.3 | 0.8 |
| Another comparison | 0.70 | 0.25 | 0.6 | 1.5 |
| embodiment | | | | |

From the result of Table 1, it is appreciated that the embodiment of the present invention obtains relatively excellent high-output characteristics since the polarization resistance is very low with respect to interface characteristics due to a high density thin film formed at a GDC buffer layer disposed between an electrolyte layer and a cathode layer. For example, in the embodiment, 0.62 W/cm² and 1.2 W/cm² are obtained at 700° C. and 800° C., respectively. That is, the performance is almost doubled in comparison to 0.30 W/cm² and 0.65 W/cm² of the comparison embodiment and 0.25 W/cm² and 0.7 W/cm² of another embodiment.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A manufacturing method for a solid oxide fuel cell (SOFC) unit cell, comprising:
manufacturing an Ni—CeScSZ anode layer;
manufacturing a CeScSZ electrolyte layer;
manufacturing a gadolinia-doped ceria (GDC) buffer layer; and
manufacturing a lanthanum strontium cobalt ferrite (LSCF) cathode layer.

2. The manufacturing method of claim 1, wherein the Ni—CeScSZ anode layer, the CeScSZ electrolyte layer, and the gadolinia-doped ceria (GDC) buffer layer are manufactured by tape casting.

3. The manufacturing method of claim 1, wherein the manufacturing of the Ni—CeScSZ anode layer comprises:
producing slurry that contains NiO and CeScSZ at the ratio of 60:40;
manufacturing an anode sheet by tape casting; and
depositing the anode sheet.

4. The manufacturing method of claim 1, wherein the manufacturing of the GDC buffer layer comprises:
producing slurry that contains GDC powder and additives at the ratio of 40:60; and
manufacturing the slurry into a thin film of about 1 μm to 10 μm by tape casting.

5. The manufacturing method of claim 1, further comprising:
depositing the CeScSZ electrolyte layer on the Ni—CeScSZ anode layer;
depositing the GDC buffer layer on the CeScSZ electrolyte layer;
depositing the CeScSZ electrolyte layer and the GDC buffer layer on the Ni—CeScSZ anode layer and performing lamination; and
performing calcining and co-firing with respect to an assembly of the Ni—CeScSZ anode layer, the CeScSZ electrolyte layer, and the GDC buffer layer.

6. The manufacturing method of claim 5, wherein the co-firing is performed at about 1300° C. to about 1500° C.

7. The manufacturing method of claim 5, wherein the calcining is performed at about 1000° C.

8. The manufacturing method of claim 1, further comprising:
applying the cathode layer on the GDC electrolyte layer by screen printing.
